(19) United States
(12) Patent Application Publication
(10) Pub. No.: US 2010/0229960 A1
(43) Pub. Date: Sep. 16, 2010

(54) INFLATABLE APPARATUS

(76) Inventors: Blaine A. Merker, San Francisco, CA (US); Matthew G. Passmore, Berkeley, CA (US); Teresa M. Aguilera, San Francisco, CA (US); John S. Bela, San Francisco, CA (US)

Correspondence Address: TIPS GROUP;c/o Intellevate LLC, P. O. BOX 52050, Minneapolis, MN, 55402, US

(21) Appl. No.: 12/559,496

(22) Filed: Sep. 14, 2009

Related U.S. Application Data
(63) Continuation-in-part of application No. 29/333,670, filed on Mar. 12, 2009, now Pat. No. D603926.
(60) Provisional application No. 61/241,891, filed on Sep. 12, 2009.

(51) Int. Cl. F16K 15/20

(52) U.S. Cl. 137/223

(57) ABSTRACT

In various embodiments, an inflatable apparatus is provided. In an embodiment, an apparatus is provided. The apparatus includes a top surface. The apparatus also includes a bottom surface connected to the top surface in a substantially airtight manner. The top surface and the bottom surface collectively define a substantially airtight chamber. The substantially airtight chamber generally has an exterior shape of a star. An internal wall extending from the top surface to the bottom surface is also provided. The internal wall is attached to the top surface and to the bottom surface in a substantially airtight manner. The internal wall, top surface and bottom surface collectively define a void. The void is contained within the bounds of the airtight chamber, the top surface and the bottom surface. The exterior shape of the apparatus includes a central portion and a plurality of lobes. The central portion includes the void. Each lobe of the plurality of lobes extends radially from the central portion. The exterior shape of the apparatus further includes internal vertices between lobes of the plurality of lobes. An inflation valve piercing the top surface and connected in a substantially airtight manner to the top surface is also provided.

### CLAIM OF PRIORITY

This application claims priority as a continuation-in-part of U.S. patent application Ser. No. 29/333,670, entitled “Inflatable Apparatus” and filed on Mar. 12, 2009, which is hereby incorporated herein by reference. This application also claims priority to U.S. Provisional Patent application Ser. No. 61/241,891, entitled “Inflatable Apparatus” and filed on Sep. 12, 2009, which is also hereby incorporated herein by reference.

### BACKGROUND

It is common for individuals to seek opportunities to relax, sit, or otherwise position themselves close to nature. However, this can be a challenging proposition in some circumstances. For example, one may not want to soil clothing or encounter dampness from the natural environment. Thus, it may be useful to provide an apparatus which can allow a person to interact with nature while allowing for separation from parts of nature.

Additionally, it is common for individuals to seek to create visually interesting structures or shapes in indoor and outdoor settings. However, it can be challenging to find flexible materials which allow for such creations. Likewise, it can also be challenging to store or transport materials which allow for structural assembly. Thus, it may be useful to provide an apparatus which an individual can transport and store simply, and which an individual can use to create various structures.

Moreover, there is often a need or demand for visual entertainment or interest beyond simple creativity or cleverness of construction. Namely, an element of whimsy or amusement can be useful when forming a structure or when interacting with nature. Thus, it may be useful to provide an apparatus which is visually interesting or amusing as well as utilitarian.

### BRIEF DESCRIPTION OF THE DRAWINGS

The present invention is illustrated by way of example in the accompanying drawings. The drawings should be understood as illustrative rather than limiting.

FIG. 1 illustrates an embodiment of an inflatable apparatus in a perspective view.

FIG. 2 illustrates a front view of inflatable apparatus in the embodiment of FIG. 1.

FIG. 3 illustrates a back view of inflatable apparatus embodiment of FIG. 1.

FIG. 4 illustrates a top view of the inflatable apparatus of FIG. 1.

FIG. 5 illustrates a bottom view of inflatable apparatus of FIG. 1.

FIG. 6 illustrates a side view of the inflatable apparatus of FIG. 1.

FIG. 7 illustrates another side view of inflatable apparatus of FIG. 1.

FIG. 8 illustrates an embodiment of a chair, composed of the inflatable apparatuses of FIG. 1

FIG. 9 further illustrates the embodiment of FIG. 8.

FIG. 10 illustrates another embodiment, the combination of inflatable apparatuses of FIG. 1.

FIG. 11 illustrates use of an embodiment of inflatable apparatus as a flotation device.

FIG. 12 illustrates another embodiment of a combination of inflatable apparatuses.

FIG. 13 illustrates yet another embodiment of a combination of inflatable apparatuses.

FIG. 14 illustrates a configuration of inflatable apparatus as a chair.

FIG. 15 illustrates another embodiment of inflatable apparatus.

FIG. 16 illustrates still another embodiment of inflatable apparatus.

FIG. 17 illustrates a cross-section of the embodiment of FIG. 1 along line A-A.

FIG. 18 illustrates a cross-section of the embodiment of FIG. 1 along line B-B.

FIG. 19 illustrates another embodiment of an inflatable apparatus in a cross-sectional view.

### DETAILED DESCRIPTION

A system, method and apparatus for an inflatable apparatus is provided. In an embodiment, an apparatus is provided. The apparatus includes a top surface and a bottom surface. The bottom surface is connected to the top surface in a substantially airtight manner. The top surface and the bottom surface collectively define a substantially airtight chamber. The substantially airtight chamber generally has an exterior shape of a star. The specific embodiments described in this document represent example instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In an embodiment, an apparatus is provided. The apparatus includes a top surface and a bottom surface. The bottom surface is connected to the top surface in a substantially airtight manner. The top surface and the bottom surface collectively define a substantially airtight chamber. The substantially airtight chamber generally has an exterior shape of a star.

In some embodiments, an internal wall extending from the top surface to the bottom surface is provided. The internal wall, top surface and bottom surface collectively define a void. The void is contained within the bounds of the airtight chamber, the top surface and the bottom surface.

In some embodiments, the exterior shape of the apparatus includes a central portion and a plurality of lobes. The central portion includes the void. Each lobe of the plurality of lobes extends radially from the central portion. Furthermore, in some embodiments, the exterior shape of the apparatus includes internal vertices between lobes of the plurality of lobes. Moreover, in some embodiments, an inflation valve pierces the top surface and is connected in a substantially airtight manner to the top surface.

In some embodiments, a plurality of internal lobe walls is provided. Each internal lobe wall is located in a lobe of the plurality of lobes. Each internal lobe wall is connected to the top surface and the bottom surface. Each internal lobe wall, along with the top surface and bottom surface, define a lobe void within each lobe of the plurality of lobes.

In some embodiments, a void inflation valve is provided. The void inflation valve pierces the top surface and is connected to the top surface in a substantially airtight manner. The void inflation valve pierces the top surface within the void.

In another embodiment, an apparatus is provided. The apparatus includes a top surface. The apparatus also includes a bottom surface connected to the top surface in a substantially airtight manner. The top surface and the bottom surface collectively define a substantially airtight chamber. The substantially airtight chamber generally has an exterior shape of a star. An internal wall extending from the top surface to the bottom surface is also provided. The internal wall is attached to the top surface and to the bottom surface in a substantially airtight manner. The internal wall, top surface and bottom surface collectively define a void. The void is contained within the bounds of the airtight chamber, the top surface and the bottom surface. The exterior shape of the apparatus includes a central portion and a plurality of lobes. The central portion includes the void. Each lobe of the plurality of lobes extends radially from the central portion. The exterior shape of the apparatus further includes internal vertices between lobes of the plurality of lobes. An inflation valve piercing the top surface and connected in a substantially airtight manner to the top surface is also provided.

In some embodiments, fasteners are attached to the apparatus at each internal vertex and at each lobe. In some embodiments, each fastener is attached to a flap (or projection) of material attached to each internal vertex and each lobe. In some embodiments, the fasteners are grommets. In some embodiments, the fasteners are selected from one of the group consisting essentially of grommets, snaps and Velcro patches. In some embodiments, an attachment component is attached to at least one of the fasteners. In some embodiments, the attachment component is a rope. In some embodiments, the attachment component is selected from one of the group consisting essentially of a rope, a cord, a strap, a ribbon and a length of twine.

In some embodiments, the top surface and the bottom surface are formed from polyvinyl. In some embodiments, the top surface is a furry surface and the bottom surface is an outdoor surface. In some embodiments, the plurality of lobes includes exactly five lobes.

In some embodiments, the top surface is heat sealed to the bottom surface. In other embodiments, the top surface and the bottom surface are collectively formed as a single component. In some embodiments, a perimeter surface is attached to a top surface and a bottom surface and is interposed between the top surface and the bottom surface.

In yet another embodiment, an apparatus is provided. The apparatus includes a central portion. The apparatus also includes a plurality of lobes arranged around the central portion and extending radially therefrom. The apparatus further includes a plurality of internal vertices defined by the plurality of lobes and situated therebetween. The central portion and the plurality of lobes each include a top surface and a bottom surface. The top surface and the bottom surface are sealed together at an edge of the plurality of lobes and an edge of the internal vertices in a substantially airtight manner.

In some embodiments, a means for inflation is provided in the top surface. In some embodiments, an internal wall in the central portion is provided. The internal wall is attached to the top surface and to the bottom surface in a substantially airtight manner. The internal wall collectively with the top surface and the bottom surface defines an internal void. In some embodiments, a means for fastening is located at each internal vertex of the plurality of internal vertices and at each lobe of the plurality of lobes.

The various embodiments illustrated herein, described above and described below may provide a variety of useful and interesting functions and features. Various embodiments described and illustrated herein are typically inflatable, thus allowing for ease of transport and storage. Moreover, such a small (un-inflated) size can be attractive to a prospective purchaser of such a product. In an inflated form, the various embodiments typically provide both utilitarian and entertaining functions. For example, forming layers of the embodiments out of brightly colored materials can provide amusing or whimsical appearances for such an apparatus—a pink or magenta star can be striking visually. Likewise, the inflated and rounded nature of the apparatus can provide a warm or non-threatening visual aspect to the apparatus—thereby inviting interaction. In its inflated form, various embodiments can be expected to provide functions such as separation from other surfaces (e.g. floors, ground, etc.), flotation, semi-rigid structural elements (e.g. portions of a wall or other geometric shape) and other functions.

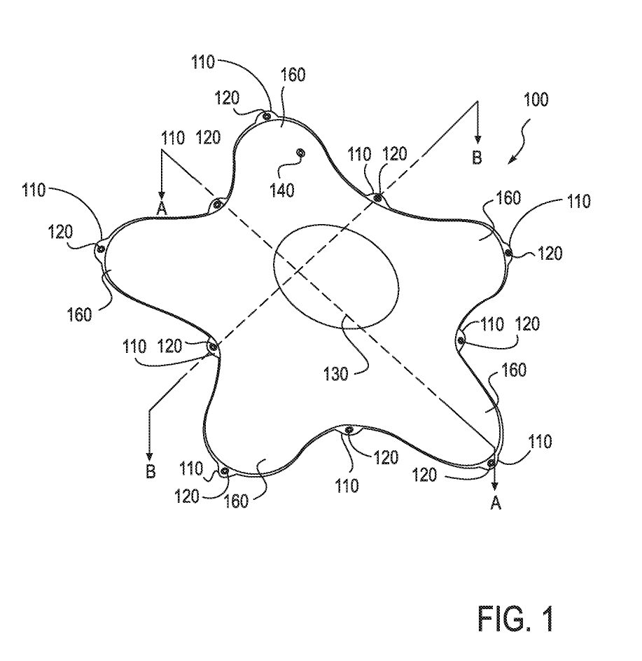

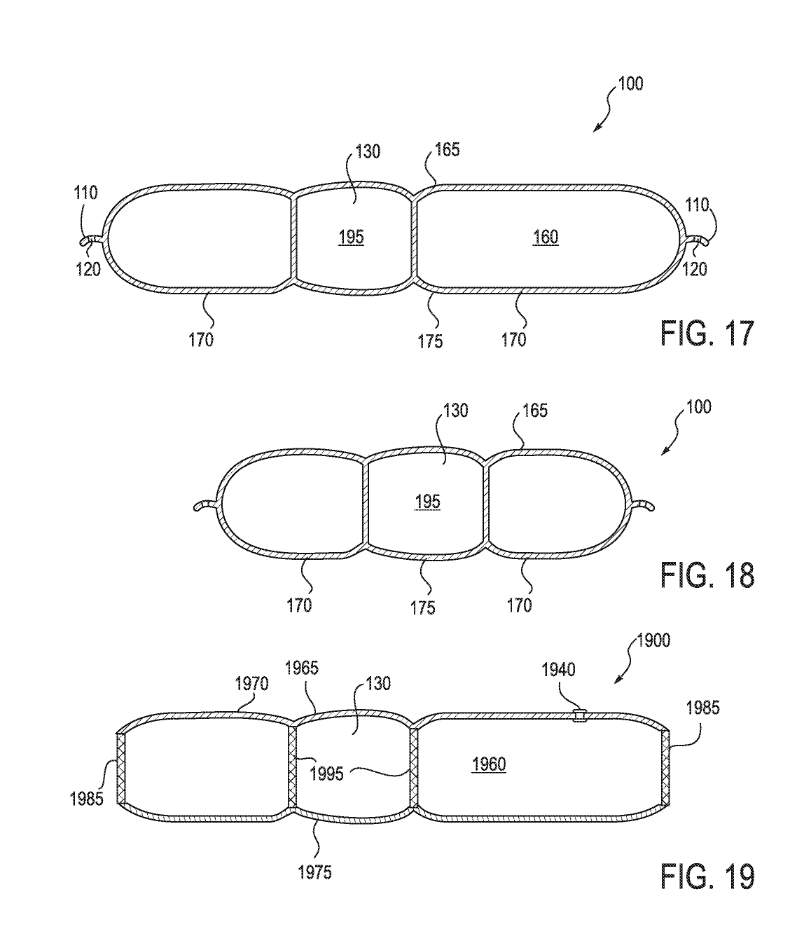

Reference to the drawings may provide additional insight into various embodiments. FIG. 1 illustrates an embodiment of an inflatable apparatus in a perspective view. Device (apparatus) 100 is an inflatable apparatus. Device 100 includes upper (165) and lower (175) surfaces or layers joined at an edge. Along the edge of device 100 are projections 110 of material, through which grommets 120 are placed. Apparatus 100 also includes a void 130 which is created by a space bounded by the upper surface 165, lower surface 175 (not shown in this figure), and an internal wall or walls (not shown) within apparatus 100. Void 130 is an airtight or substantially airtight internal space within apparatus 100, which provides structural stability and allows for equal air pressure in all directions in apparatus 100. Alternatively, void 130 may be a solid internal portion of apparatus 100. Apparatus 100 also includes inflation valve(s) 140, which penetrate the upper surface (one or more valves may be used). The valves may be placed in various locations as appropriate for a given design. Also provided for reference, are reference lines, A-A and B-B along which cross-sections are shown in FIGS. 17 and 18.

In the embodiment illustrated, five lobes 160 are formed around a central core area 170. The overall shape is that of a star or pentagonal structure. Other shapes may be used in other embodiments, and the shape may be varied in different ways as necessary to achieve different design goals. As illustrated, the apparatus provides an essentially airtight inflatable device which may be used for recreational and utilitarian purposes in a variety of environments.

The upper and lower surfaces, along with the internal walls and material forming or connected to an edge of apparatus 100 may be made from a variety of materials. In one embodiment, such surfaces are formed from polyvinyl or similar material (e.g. PVC). In other embodiments, other materials may be used. In some embodiments, flexible, airtight (or generally non-gas-permeable) materials can be used, such as polymer-based materials, rubber, bioplastics and biopolymers. In particular, multiple materials may be used, rather than a single material. For example, a fuzzy side may be used for a top surface, using a synthetic fur, while a tougher material such as polyvinyl, PTFE, or even canvas may be used for the bottom surface to create an outdoor or tougher side. In the event of use of an outer layer which is not airtight (which is gas-permeable), an impermeable layer would need to be added (not shown).

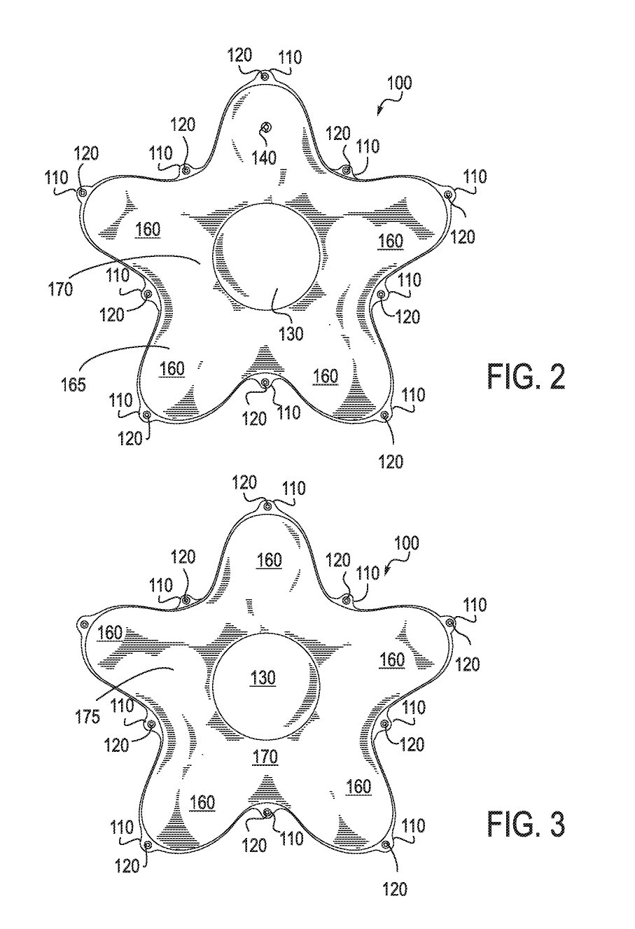

Reference to front and back views of the embodiment of FIG. 1 may be illustrative. FIG. 2 illustrates a front view of the inflatable apparatus in the embodiment of FIG. 1. Similarly, FIG. 3 illustrates a back view of the inflatable apparatus embodiment of FIG. 1. As is apparent, grommets 120 are placed through projections material 110 at each inner and outer vertex of the perimeter of apparatus 100. Other arrangements for such grommets may also be used in other designs. Additionally, other fasteners may be used, such as snaps, Velcro strips, rings (attached to projections 110), interlocking tabs, or other fasteners. Grommets and similar fasteners (such as loops of the material of projections 110) allow for use of material such as cord, rope, string, straps, thread or other material or components used in coupling items together in either a loose or tight fashion.

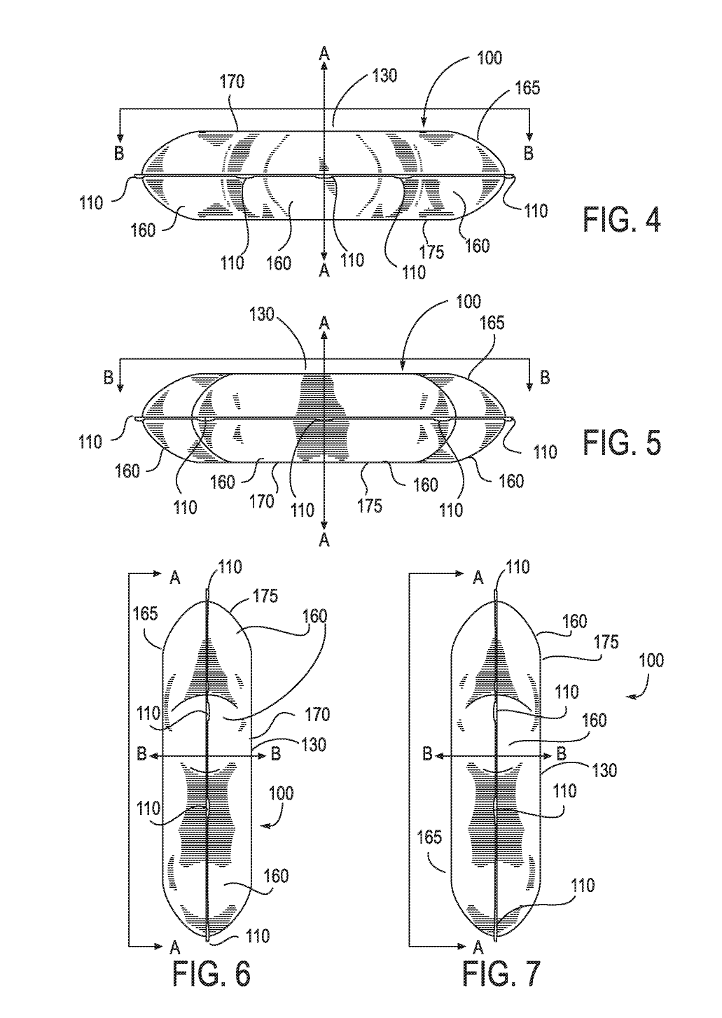

Other views of the apparatus of FIG. 1 are shown for further understanding of how some embodiments may be formed. FIG. 4 illustrates a top view of the inflatable apparatus of FIG. 1. FIG. 5 illustrates a bottom view of the inflatable apparatus of FIG. 1. FIG. 6 illustrates a side view of the inflatable apparatus of FIG. 1. FIG. 7 illustrates another side view of the inflatable apparatus of FIG. 1. Each view illustrates the embodiment of FIG. 1 as previously described. Note that lines A-A and B-B are reproduced for reference as well.

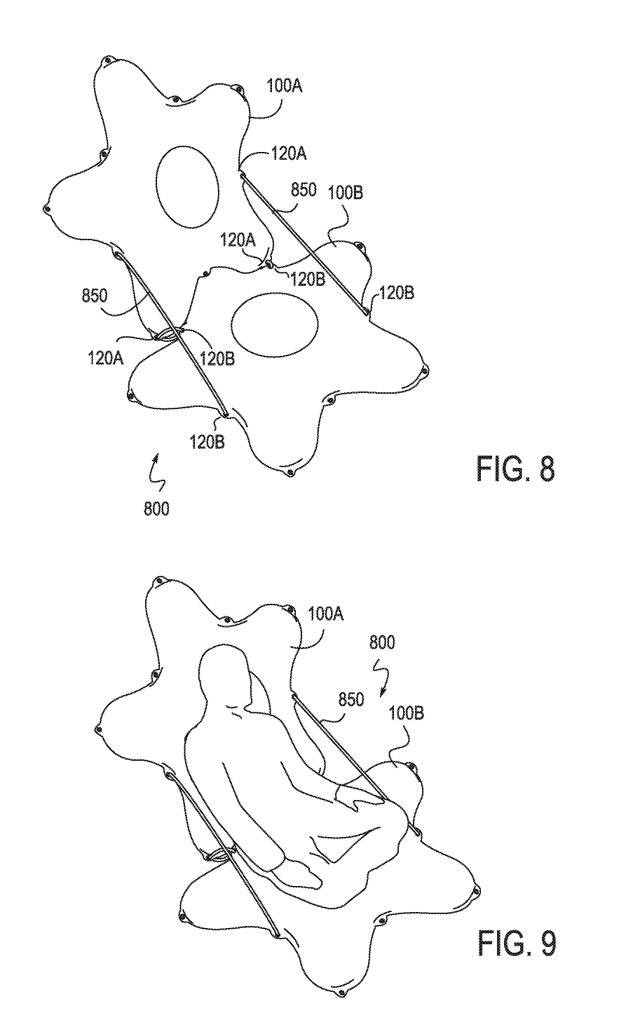

The inflatable apparatus can be formed into a wide variety of shapes. FIG. 8 illustrates an embodiment of a chair, composed of multiple copies of the inflatable apparatus of FIG. 1. Assembly 800 uses inflatable apparatuses 100 to form a chair. Cord 850 is threaded through grommets 120A of apparatus 100A and grommets 120B of apparatus 100B to join (couple) the two inflatable apparatuses together. As may be apparent, cord 850 can be a single cord (or rope, e.g.) which loops through all of the illustrated grommets and shown. Alternatively multiple cords may be used. FIG. 9 further illustrates the embodiment of FIG. 8. As can be seen in FIG. 9, a person can comfortably sit in the chair thereby created. However, the size and scale of the apparatus 100 can be varied within some limits for different purposes. Thus, apparatus 100 may be sized for personal use, providing an apparatus approximately three feet (e.g. approx. 1 m) wide along line A-A of FIG. 1, for example. Alternatively, apparatus 100 may be sized for smaller sizes, such as with a width of approximately one foot (e.g. approx. 30 cm) or smaller, or for larger sizes as well. In some embodiments, a smaller-sized apparatus need not have a void incorporated (and this may be workable for various different sizes). Larger-sized apparatuses may include more voids in the interest of allowing for manufacturability and stability.

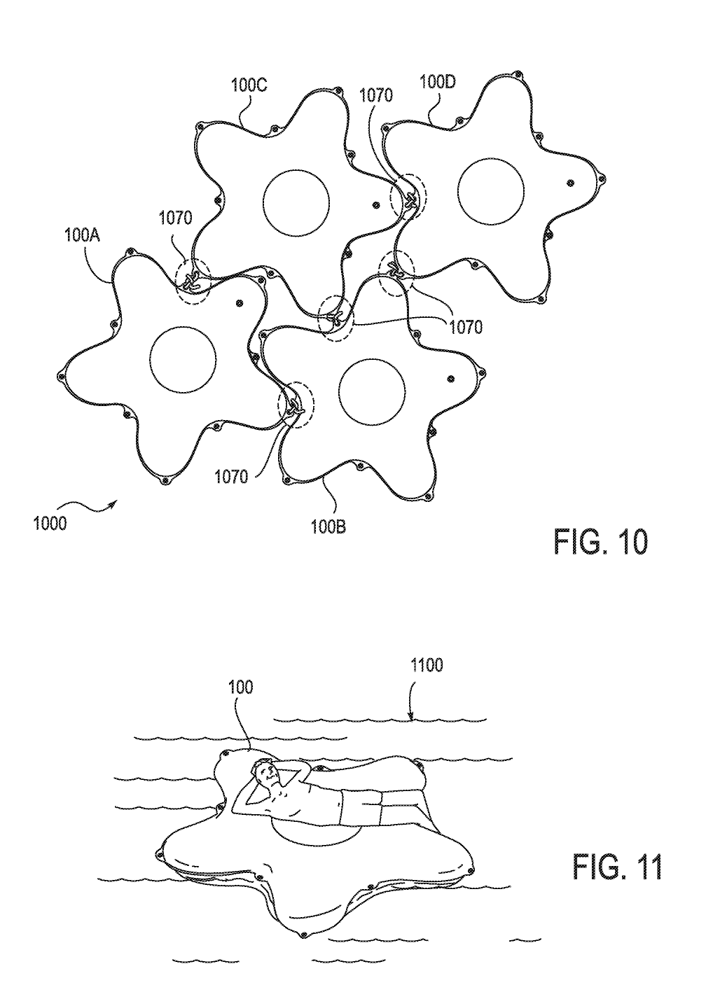

Other configurations of inflatable apparatus may also be useful. FIG. 10 illustrates another embodiment, a combination of inflatable apparatuses of FIG. 1. The combination 1000 shown is a combination of several inflatable apparatuses 100 (A, B, C and D) joined to form a flat surface. Cords 1070 are used in grommets 120 of the various inflatable apparatuses 100A, 100B, 100C and 100D. Such a flat surface may be used as playing surface or as an area to lie on, for example. Alternatively, cords 1070 in conjunction with grommets 120 may act as hinges between apparatuses 100, allowing for one or more apparatuses 100 to be pivoted or rotated in relation to the other apparatuses 100.

As another alternative, FIG. 11 illustrates use of an embodiment of inflatable apparatus 100 as a flotation device. The inflatable apparatus 100 is shown in a body of water 1100 where it is used as an inflatable cushion. As shown, in some embodiments, a person can rest on an upper surface of apparatus 100 and thereby float within (on) water 1100. Alternatively, a larger structure may be used to allow for multiple people to fit on a single apparatus 100. FIG. 11 is not intended to show a scaled view of a specific embodiment.

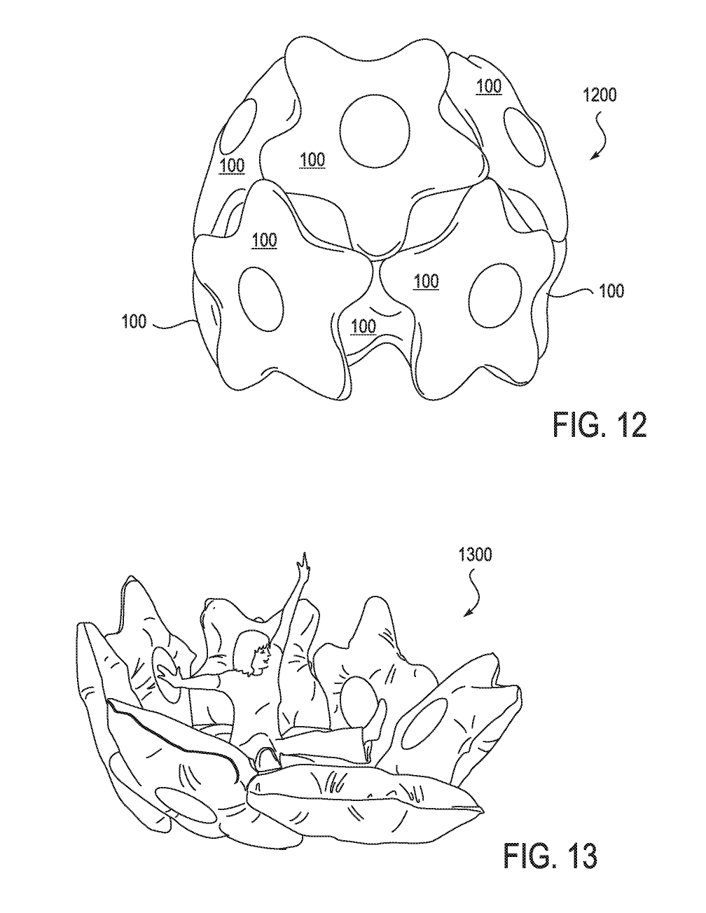

Configurations of the inflatable apparatus may form many different shapes. FIG. 12 illustrates another embodiment of a combination of inflatable apparatuses. Structure 1200 is made up of a number of inflatable apparatuses joined together to create a geometric shape. The inflatable apparatuses may be tessellated or combined into various different geometric shapes, and may be used to provide a play structure or a shelter or a three-dimensional cushion object. Note that tessellation is referred to herein, even though it may not be possible to meet the strict definition of tessellation in forming some of the combinations of embodiments of an inflatable apparatus. For purposes of this document, tessellation refers to combination of multiple inflatable apparatuses in an interlocking or joined manner, rather than strict tessellation according to mathematical definitions.

These variations on shapes of configurations of inflatable apparatus are many. FIG. 13 illustrates yet another embodiment of a combination of inflatable apparatuses. Shape 1300 provides a bowl in which an individual can sit. Shape 1300 is made of one (illustrated) or several inflatable apparatuses forming a base, all of which are connected together and to which is connected a number of additional apparatuses forming walls of the shape 1300. In one embodiment, the connections or couplings between the apparatuses of the walls of the shape 1300 serve to form a ring of apparatuses which stand at the illustrated angle from the base apparatus or apparatuses.

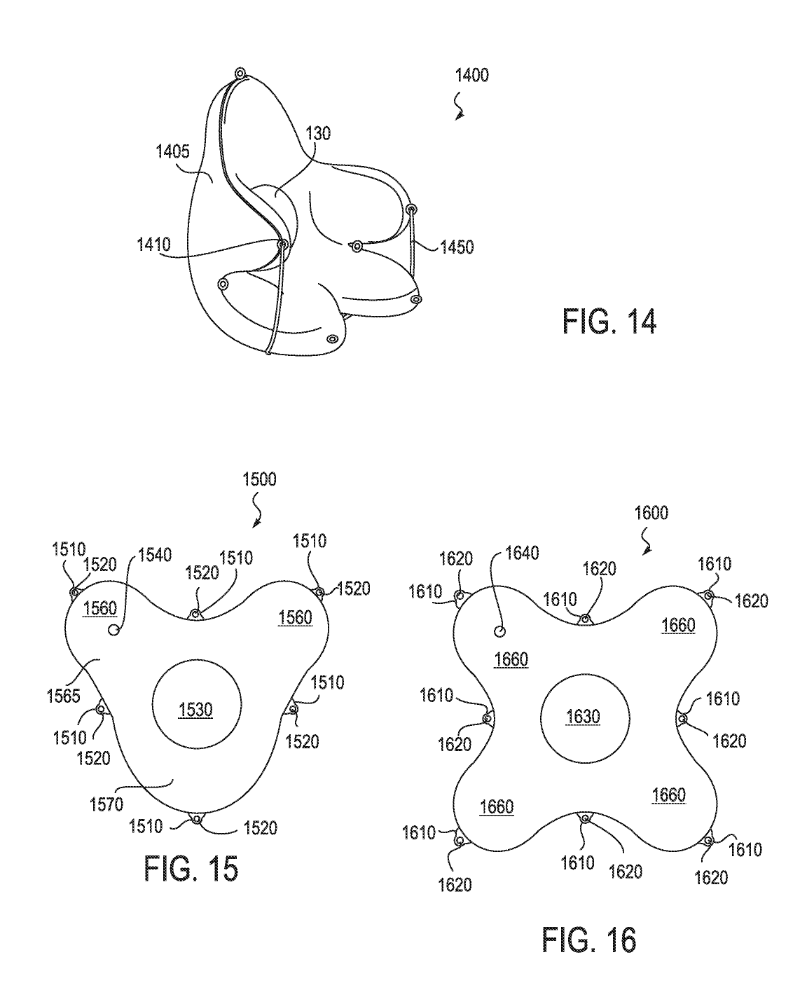

The inflatable apparatus can also be configured singly rather than in combination. FIG. 14 illustrates a configuration of inflatable apparatus as a chair. Chair 1400 is illustrated using an embodiment of an inflatable apparatus 1405 which has rings attached to the edge (e.g. projection 110 of apparatus 100) rather than grommets. Two rings 1410 have cord 1450 threaded through the rings 1410, with the cord 1450 looped around two arms of the inflatable apparatus 1405 pulling the inflatable apparatus into a chair shape. Note that apparatus 1405 may be formed very similarly to apparatus 100 of FIG. 1. Alternatively, apparatus 1405 may be formed in a different manner with an exterior perimeter material extending vertically between an upper surface and a lower surface, such as is illustrated in FIG. 19.

Other shapes may also be useful. FIG. 15 illustrates another embodiment of inflatable apparatus. The inflatable apparatus 1500 includes two arms and a circular body and also includes projections 1510 in grommets 1520 therethrough along with void 1530 and valve 1540. Thus, an upper (1565) and lower (1575) layer are still used to form the exterior surfaces of apparatus 1500. The shape of apparatus 1500 is different from that of apparatus 100, forming a rounded triangular shape, and allowing for different configurations. Void 1530 is shown as it may be necessary in some configurations to provide an inflatable design.

FIG. 16 illustrates still another embodiment of an inflatable apparatus. Inflatable apparatus 1600 includes four arms or lobes mounted about a center. Protrusions 1610 are shown at ends of arms and junctions and arms. Grommets 1620 pierce protrusions 1610. Also included in apparatus 1600 are a void 1630 in center 1670 and inflation valve 1640 on an arm 1660. Upper surface 1665 and lower surface 1675 may be formed similarly to surfaces or layers in other embodiments. As is apparent, one can form such an inflatable apparatus with a number of different lobes, such as three, six, or some other number distinct from the examples illustrated in the drawings of this document. Likewise, one may form the lobes in a variety of different shapes, and need not maintain an overall shape with a single center, for example. Such variations remain within various embodiments.

Cross-sections may further illustrate the formation of such embodiments. FIG. 17 illustrates a cross-section of the embodiment of FIG. 1 along line A-A. Apparatus 100 is shown with void 130 contained within central area 170. One arm or lobe 160 is shown, whereas the line A-A intersects on the other side an internal vertex of apparatus 100. Thus, projections 110 are shown with grommets 120 therethrough (the perspective of projections 110 and grommets 120 is tilted slightly relative to the cross-section). From the illustration, it is clear that void 130 is a separate compartment from the rest of the interior of apparatus 100. In some embodiments, void 130 may be formed with a separate inflation valve, for example. FIG. 18 illustrates a cross-section of the embodiment of FIG. 1 along line B-B. The cut along line B-B shows the central area 170 containing void 130. It does not intersect any projections material 110 or grommets 120, for example. Note that in some embodiments, projections material 110 may extend around the entire perimeter of the apparatus 100. Also, note that both cross-sections show interior walls 195 of apparatus 100, which separate void 130 from the rest of the interior of the apparatus 100.

Another embodiment may be formed with an exterior perimeter wall. FIG. 19 illustrates another embodiment of an inflatable apparatus in a cross-sectional view. Apparatus 1900 is formed from an upper layer 1965 and a lower layer 1975, each of which is joined to a perimeter layer 1985. Projections material may be attached to layer 1985, or at the join (e.g. seam, junction) of layer 1985 to either 1965 or 1975, for example. In some embodiments, layers 1965, 1975 and 1985 may be formed as a unitary body, with no seams therebetween. Central portion 1970 is shown containing void 1930, which is bounded by upper layer 1965, lower layer 1975 and interior wall(s) 1995. Also, valve 1940 is shown piercing upper layer 1965 in lobe 1960. Thus, FIG. 19 illustrates an alternate cross-section for an embodiment such as embodiment 100 of FIG. 1.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. An apparatus, comprising:
a top surface; and
a bottom surface connected to the top surface in a substantially airtight manner, the top surface and the bottom surface collectively defining a substantially airtight chamber and wherein the substantially airtight chamber generally has an exterior shape of a star.

2. The apparatus of claim 1, further comprising:
an internal wall extending from the top surface to the bottom surface, the internal wall, top surface and bottom surface collectively defining a void, the void contained within the bounds of the airtight chamber, the top surface and the bottom surface.

3. The apparatus of claim 2, wherein:
the exterior shape of the apparatus includes a central portion and a plurality of lobes, the central portion including the void, each lobe of the plurality of lobes extending radially from the central portion.

4. The apparatus of claim 3, wherein:
the exterior shape of the apparatus further includes internal vertices between lobes of the plurality of lobes.

5. The apparatus of claim 4, further comprising:
an inflation valve piercing the top surface and connected in a substantially airtight manner to the top surface.

6. (canceled)

7. (canceled)

8. An apparatus, comprising:
a top surface;
a bottom surface connected to the top surface in a substantially airtight manner, the top surface and the bottom surface collectively defining a substantially airtight chamber and wherein the substantially airtight chamber generally has an exterior shape of a star;
an internal wall extending from the top surface to the bottom surface, the internal wall attached to the top surface and to the bottom surface in a substantially airtight manner, the internal wall, top surface and bottom surface collectively defining a void, the void contained within the bounds of the airtight chamber, the top surface and the bottom surface;
the exterior shape of the apparatus includes a central portion and a plurality of lobes, the central portion including the void, each lobe of the plurality of lobes extending radially from the central portion;
the exterior shape of the apparatus further includes internal vertices between lobes of the plurality of lobes; and
an inflation valve piercing the top surface and connected in a substantially airtight manner to the top surface.

9. The apparatus of claim 8, further comprising:
fasteners attached to the apparatus at each internal vertex and at each lobe.

10. The apparatus of claim 9, wherein:
each fastener is attached to a flap of material attached to each internal vertex and each lobe.

11. The apparatus of claim 10, wherein:
the fasteners are grommets.

12. The apparatus of claim 10, wherein:
the fasteners are one of the group consisting essentially of grommets, snaps and Velcro patches.

13. The apparatus of claim 10, further comprising:
an attachment component attached to at least one of the fasteners.

14. The apparatus of claim 13, wherein:
the attachment component is a rope.

15. (canceled)

16. The apparatus of claim 8, wherein:
the top surface and the bottom surface are formed from polyvinyl.

17. (canceled)

18. The apparatus of claim 8, wherein:
the plurality of lobes includes exactly five lobes.

19. The apparatus of claim 8, wherein:
the top surface is heat sealed to the bottom surface.

20. The apparatus of claim 8, wherein:
the top surface and the bottom surface are collectively formed as a single component.

21. An apparatus, comprising:
a central portion;
a plurality of lobes arranged around the central portion and extending radially therefrom;
a plurality of internal vertices defined by the plurality of lobes and situated therebetween;
wherein the central portion and the plurality of lobes each include a top surface and a bottom surface, the top surface and the bottom surface sealed together at an edge of the plurality of lobes and an edge of the internal vertices in a substantially airtight manner.

22. The apparatus of claim 21, further comprising:
a means for inflation in the top surface.

23. The apparatus of claim 22, further comprising:
an internal wall in the central portion, the internal wall attached to the top surface and to the bottom surface in a substantially airtight manner, the internal wall collectively with the top surface and the bottom surface defining an internal void.

24. The apparatus of claim 22, further comprising:
means for fastening located at each internal vertex of the plurality of internal vertices and at each lobe of the plurality of lobes.
